(19) United States
(12) Patent Application Publication
(10) Pub. No.: US 2007/0002348 A1
(43) Pub. Date: Jan. 4, 2007

(54) Method and apparatus for producing images by using finely optimized image processing parameters

(75) Inventor: Takahiro Hagiwara, Chiba-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/079,189

(22) Filed: Mar. 15, 2005

(51) Int. Cl. G06F 3/12

(52) U.S. Cl. 358/1.13; 358/1.9

(57) ABSTRACT

Method and apparatus for producing images by printing a print data are provided. The print data is a data produced, for example, by a printer driver of a computer and is described in a PDL. The image producing apparatus analyzes commands described in the print data to determine the type of an object depicted by the print data, and to determine attributes other than the type of the object as determined. An image processing pattern consisting of a group of one or more image processing parameters is set depending on the type of the object as determined and the results of the determinations on the attributes. The print data is provided with image processing based on the image processing parameters determined by the image processing pattern.

### BACKGROUND OF THE INVENTION

1. Field of the Invention

The present invention relates to a method and apparatus for producing images by performing printing of print data. Particularly, this invention relates to a method and apparatus for producing images by analyzing the printing commands imparted to the print data to determine image processing parameters, and by performing printing after processing the print data based on the image processing method.

2. Related Art

Many of printers and MPF (multi-function peripherals) devices these days are capable of not only printing the data of an object to be printed, but also obtaining optimum printing results depending on various kinds of print data. Specifically, many of these devices have a function of optimizing the results of printing by switching color conversion processes and halftone patterns, depending on the type of an object to be printed, i.e. text data, graphics data and bitmap data consisting the object.

A specific example is described in Japanese Published Unexamined Patent Application No. 09-193477, in which the color printer has functions of analyzing printing commands in a print data described in a page description language (PDL), determining the type (text data, graphics data or bitmap data) of an image of each of the objects provided by the print data, selecting a color correction table corresponding to each of the types of objects as determined, effecting color correction using the selected color table, and composing the corrected print data of each of the objects for further printing processes. The color correction tables are adapted to be rewritable by a user.

Other known functions include increasing screen line number in case an object consisting of text data, for example, to improve resolution for the visual clarity of character edges. Contrarily, another function is also known that, in case of a bitmap data such as photographs, screen number is rather prevented from increasing to make color changes smooth for placing greater importance on finished color gradation. In carrying out an inking process for text data or graphics data, the black color portions are typically printed with a single black toner. However, in carrying out an inking process for bitmap data, such a function is often used as performing printing with mixed color of black toner and color toner. This is because printing such bitmap data with a black toner alone creates a visually unnatural impression.

Such uniform parameters (e.g. degree of half-toning, degree of gamma correction, effectiveness of spatial filtering, and degree of inking) as described above have been applied to printers, which parameters depending on the type of an object as determined, i.e. text data, graphics data or bitmap data. Thus, any objects consisting of text data, for example, have applied uniform image-processing parameters irrespective of the sizes of the characters therein. Likewise, any objects consisting of graphics data have applied uniform image-forming parameters irrespective of whether or not the data are of fine ruler lines, of cells painted with gray color, of patterns painted with some colors, or the like. In case of bitmap data, image processing focused on gradation has typically been effected because such data mostly includes photographic data (natural images). However, some bitmap data, such as CAD data based on characters and lines, and scanned data based on written documents, include image data which may rather be classified as text or graphics data. Even in this type of bitmap data, image processing applying uniform image processing parameters has been implemented.

Printing results, however, have been pointed out as being influenced by minute differences in the attributes of an object, such as sizes, colors, and depicting (rendering) positions, other than the type of the object. Particularly, if certain objects are of the same type, the difference in their attributes, such as sizes, colors, depicting positions or the like, may frequently cause such problems as uneven density, insufficient density, deterioration in the reproducibility of the objects, and misregistration. Conventional printers have not taken sufficient measures for these problems.

### SUMMARY OF THE INVENTION

According to an aspect of the present invention, the apparatus for producing images by performing printing of print data, comprises: an object determining device for determining the type of an object depicted by the print data upon analysis of the commands described in the print data, and determining attributes other than the type of the object as determined; a pattern setting device for setting an image processing pattern consisting of a group of one or more image processing parameters depending the determination on the type of the object and the results of the determinations on the attributes other than the type of the object, made by the object determining device; and a print data processor for providing the print data with image processing based on the image processing parameters determined by the image processing pattern which has been set by the pattern setting device.

According to another aspect of the present invention, the method of producing images by performing printing of print data comprises: determining the type of an object depicted by the print data upon analysis of the commands described in the print data, and determining attributes other than the type of the object as determined; setting an image processing pattern consisting of a group of one or more image processing parameters depending on the determination on the type of the object and the results of the determinations on the attributes; and providing the print data with image processing based on the image processing parameters determined by the image processing pattern that has been set.

According to still another aspect of the present invention, a program is provided which is readably recorded in a memory and is executable by a computer, wherein, by executing the program, the computer is functioned as: object determining means for determining the type of an object depicted by the print data upon analysis of the commands described in the print data, and determining attributes other than the type of the object as determined; pattern setting means for setting an image processing pattern consisting of a group of one or more image processing parameters depending on the determination on the type of the object and the results of the determinations on the attributes made by the object determining means; and print data processing means for providing the print data with image processing based on the image processing parameters determined by the image processing pattern which has been set by the pattern setting means.

### BRIEF DESCRIPTION OF THE DRAWINGS

In the accompanying drawings:

FIG. 1 is a schematic block diagram showing a configuration of one embodiment of a printing system in which an image producing apparatus according to the present invention is implemented;

FIG. 2 is an explanatory diagram showing the printing processes in the printing system according to the embodiment;

FIG. 3 is an illustration showing an example of the results of determinations, executed in the embodiment, on the type of print data and on the attributes other than the type;

FIG. 4 is an explanatory diagram showing an example of a tag information management table;

FIG. 5 illustrates graphs showing an example of an analysis on the attributes in the individual groups throughout the whole bitmap data;

FIG. 6 is an explanatory diagram showing an example of the results of determinations on the attributes in the individual groups throughout the whole bitmap data;

FIG. 7 is an explanatory diagram showing an example of an image processing pattern conversion table;

FIG. 8A is an exemplary illustration showing an image processing pattern table in a standard mode;

FIG. 8B is an exemplary diagram showing an image processing pattern table in a high-resolution mode;

FIG. 9 is an exemplary diagram showing a determination/classification conversion table for bitmap data used in the embodiment;

FIG. 10 is an exemplary diagram showing an image processing pattern in a standard mode;

FIG. 11 is an exemplary diagram showing an image processing pattern in a high-resolution mode;

FIG. 12 is an explanatory diagram showing an algorithm for determining the relation between two groups of divided bitmap data;

FIG. 13 is an explanatory diagram showing specific processes of the algorithm shown in FIG. 12;

FIG. 14 is an explanatory diagram showing another algorithm for determining the relation between two groups of divided bitmap data;

FIG. 15 is an explanatory diagram showing specific processes of the algorithm shown in FIG. 14;

FIG. 16 is a flow diagram for explaining a series of processes of print data from the determinations on the type and attributes of an object, through preprocessing and depiction, to data compaction executed by an RIP in the embodiment;

FIGS. 17 to 20 are sub-routines showing determinations on the attributes of an object, which are executed in the processes shown in FIG. 16;

FIG. 21 is a flow diagram explaining a series of processes from data expansion to printing executed by a postprocessor in the embodiment;

FIG. 22 is a sub-routine for explaining the postprocessing for print image data, which is executed in the processes shown in FIG. 21; and

FIG. 23 is an explanatory diagram showing postprocessing for print image data.

### DETAILED DESCRIPTION OF THE PREFERRED EMBODIMENT

Hereinafter is described one preferred embodiment of an apparatus and method for producing images according to the present invention. In this embodiment, the image producing apparatus according to the present invention is implemented as an MFP (multi-function peripherals) device, and the image producing method is executed by such an MFP device.

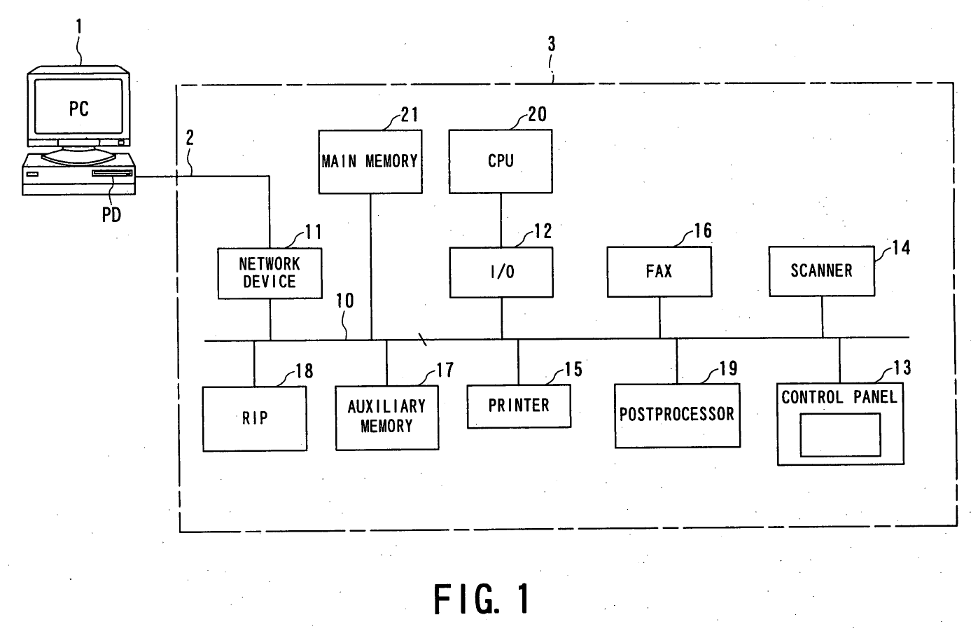

FIG. 1 schematically shows a printing system comprising a computer 1 such as a personal computer, and an MPF device 3 which is connected to the computer 1 through a network 2.

It should be appreciated that this MFP device 3 is employed as an example for the image producing apparatus, and that the image producing apparatus is not necessarily limited to the MFP device 3. The MFP device 3 may be replaced by a distributed system as described later, which comprises functions of the individual portions of the MFP device 3 as separate units, or may be replaced by a printer per se integrally incorporating such individual functions.

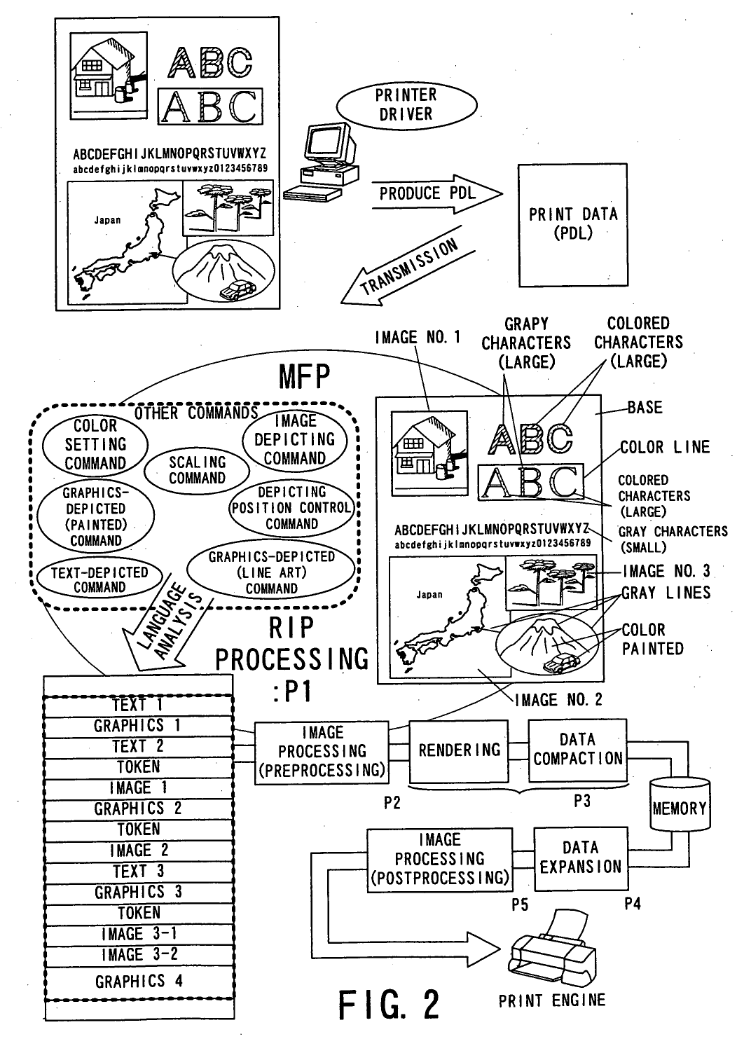

To briefly explain the printing system, the computer 1 has a printer driver PD. Accordingly, the computer 1 produces an original to be printed into a print data in terms of a page description language (PDL) using the printer driver PD (see FIG. 2). The print data is transmitted to the MFP device 3 through the network 2. The network 2 may be, for example, a public telephone line, a LAN (local area network) or an internet. The print data transmitted to the MFP device 3 is processed into a print image data and then printed. The course of processing of the print data into the print image data in the MFP device 3 constitutes a feature of the apparatus and method for producing images according to the present invention, and exerts effects characteristic of the present invention. The details of this are described hereinafter.

An outline of the configuration and the process flow of the MFP device 3 are described below with reference to FIGS. 1 and 2.

As shown in FIG. 1, the MFP device 3 comprises a network device 11 intervening between an internal bus 10 and the external network 2, input/output (I/O) controller 12 connected to the bus 10, a control panel 13, a printer 15, a fax device 16, an auxiliary memory 17, an RIP (Raster Image Processor) 18, and a postprocessor 19, which are all adapted to exchange signals with each other through the bus 10. The control panel 13 presents a touch-panel type large display screen pertaining to the printer 15.

The MFP device 3 also comprises a CPU (Central Processing Unit) 20 for performing reading/writing of data through the I/O controller 12, and a main memory 21 for storing in advance predetermined fixed data and program data required by the CPU 20. Thus, upon startup, the CPU 20 reads the program data from the main memory 21 and performs operation/control according to the procedures indicated by the program. The data required for the operation/control is read by the CPU 20 through the I/O controller 12, and the data resulting from the operation/control is outputted from the CPU 20 through the I/O controller 12.

Each of the internal printer 15, fax device 16, auxiliary memory 15, RIP 18 and postprocessor 19 in the MFP device 3 operates under the control of the CPU 20.

Among them, the printer 15 serves as a printing machine for the MFP device 3, by performing printing of the print data transmitted through the bus 10 by a print command. The fax device 16 faxes the print image data transmitted through the bus 10 by a fax command. The auxiliary memory 17 comprises a data writing/reading circuit, not shown, and is adapted to write/read, under the control of the CPU 20, the print data or data being processed to/from an internal memory through the data writing/reading circuit for temporal storage of the data.

Further, the RIP 18 is adapted to read out the program stored in advance in the main memory 21 or the auxiliary memory 17, for example, and to carry out processes described later along the procedures described in the program. Thus, the RIP 18 also performs processes characteristic of the present invention. Specifically, besides carrying out the primary process (process P1) of producing a print image data by the language analysis of the print data, the RIP 18 also carries out determination/classification (process P2) of the type of an object to be depicted (rendered), and carries out processes of the print data starting from preprocessing to storage in the memory (process P3), in parallel with the process P1. Thus, in the present embodiment, the RIP 18 also has a function as a preprocessor for the print data.

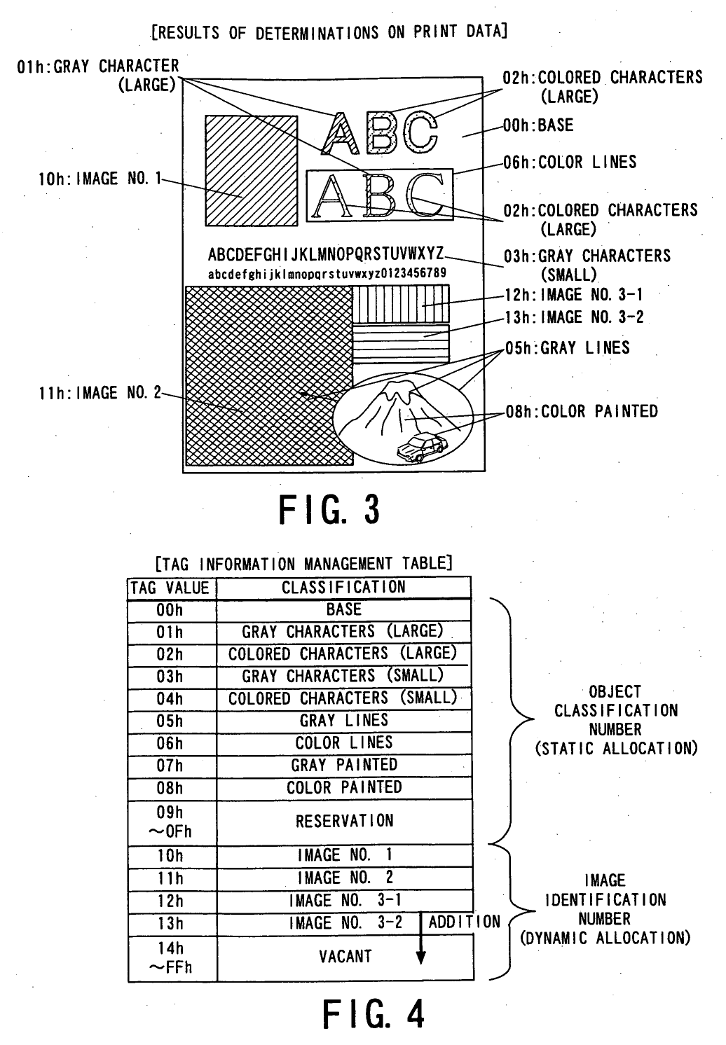

The language analysis mentioned above includes determinations on a text (characters) depicting command, graphics (line art) depicting command, graphics (painting) depicting command, bitmap (image) depicting command, color setting command, scaling command, and depicting position control command. The determination/classification of the type of an object to be depicted (rendered) is made based on the current setting condition recognized as a result of determinations on the various commands mentioned above, and on the combination of the depicting commands. In this way, the RIP 18 produces data (see FIG. 3) indicative of a type of a depicted object as determined/classified, and subjects the data to preprocessing.

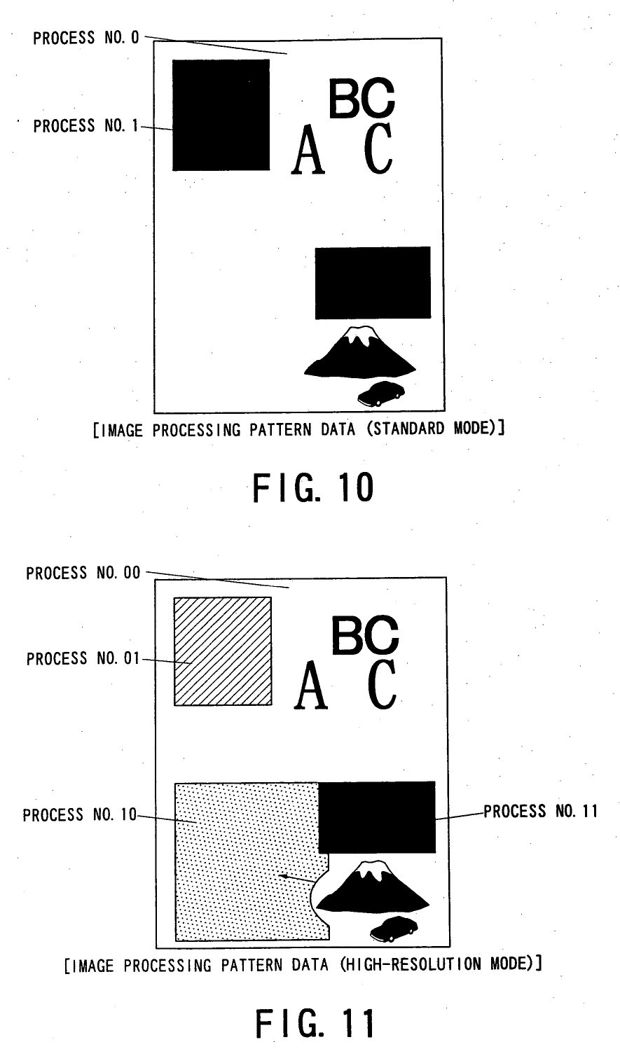

This preprocessing includes processes that constitute a part of the features of the present invention. Specifically, as will be described later, the RIP 18 is adapted to produce image processing pattern data (see FIGS. 10 and 11) depending on the determination/classification of the type of a depicted object.

The image processing pattern data herein means a data specifying an image processing pattern set for every pixel. An image processing pattern consists of a group of a plurality of image processing parameters (spatial filtering process, color converting process, inking process, gamma correction process, and half-toning process), each being variable. The image processing pattern related to the present embodiment is set for each of the “standard mode” and the “high-resolution mode” that can be selected by a user.

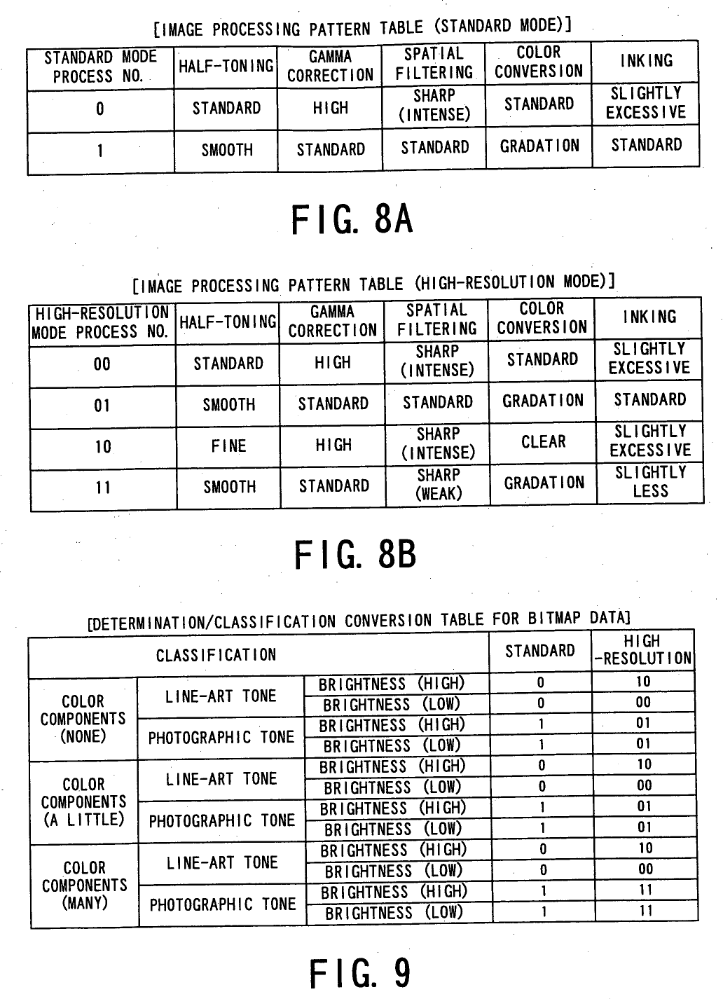

As to the “standard mode” image processing pattern, two types of parameter groups (Process No. “0” or “1”) are prepared (see FIG. 8A). Either of the image processing patterns can be selectively specified by specifying the image processing pattern data of either of the Process Nos. “0” and “1”. As can be seen from FIG. 8A, the values of the image processing parameters are different from each other between the two types of mage processing patterns of the standard mode. The difference depends on the type and attributes (i.e. items, other than the type, for determining the properties of the object) of a depicted object, and each of the parameter values is set so that each of the object data can be optimally depicted. Specific examples of such parameter values are described later.

As to the “high-resolution mode” image processing pattern, four types of parameter groups (Process No. “00”, “01”, “10” or “11”) are prepared in the table (see FIG. 8B). Any one of the parameter groups as an image processing pattern can be selectively specified by specifying any of the image processing pattern data Process Nos. “00”, “01”, “10” and “11”. As can be seen from FIG. 8B, the values of at least some image processing parameters are different from each other between the four image processing patterns of the high-resolution mode. The difference also depends on the type and attributes (items, other the types, for determining the properties of the object) of a depicted object, and each of the parameter values is set so that each of the object data can be optimally depicted. Specific examples of such parameter values are described later.

Referring back to FIG. 2, the print data subjected to preprocessing in the RIP 18 is then subjected to depicting processing. Thus, a print mage data provided with a predetermined depicting processing is produced.

It should be appreciated that, in the RIP 18, production of the image processing pattern data by the preprocessing and production of the print mage data by the depicting processing are carried out in parallel.

Further, in the RIP 18, the print image data and the image processing pattern data produced as described above, are subjected to data compaction and transmitted to the auxiliary memory 17 for storage as compacted data.

Upon issuance of a print command from the CPU 20, the postprocessor 19 reads out the print image data and the image processing pattern data corresponding to the print command from the auxiliary memory 17 for expansion (Process P4 in FIG. 2). The expanded data (the print image data and the image processing-pattern data) are subjected to predetermined postprocessing (Process P5). This postprocessing also constitutes a part of the features of the present invention, and includes spatial filtering process, color conversion process, inking process, gamma correction process, and/or half-toning process. Specifically, the print data is scanned for every pixel, and in synchronous with which, the image processing data pattern is scanned as well for every pixel to apply an image processing pattern, which is specified for every pixel by the image processing pattern data, to the print data, i.e. to apply image processing based on the plurality of image processing parameters to the print data.

Thus, the print image data finished with the postprocessing based on the various image processing parameters depending on a depicted object, is transmitted to the printer 15. The printer 15 is adapted to start up a printer engine to print the print image data per page.

As to some processes described above, the processes characteristic of the present invention are now described in detail below.

[Determination on the Type of a Depicted Object by the RIP]

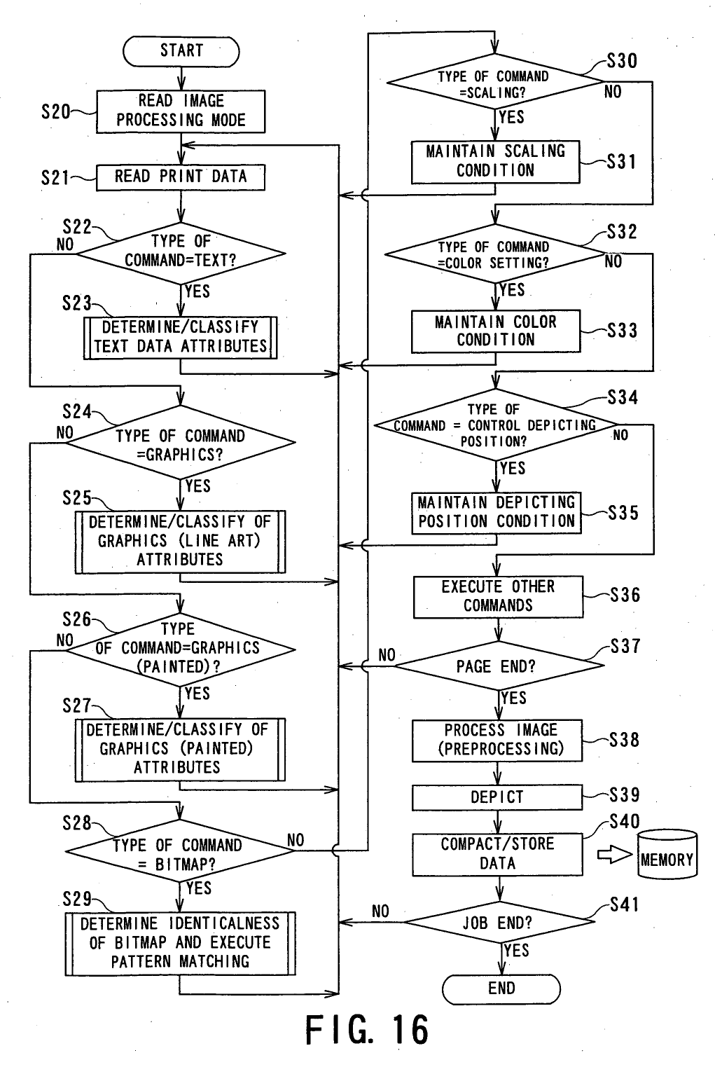

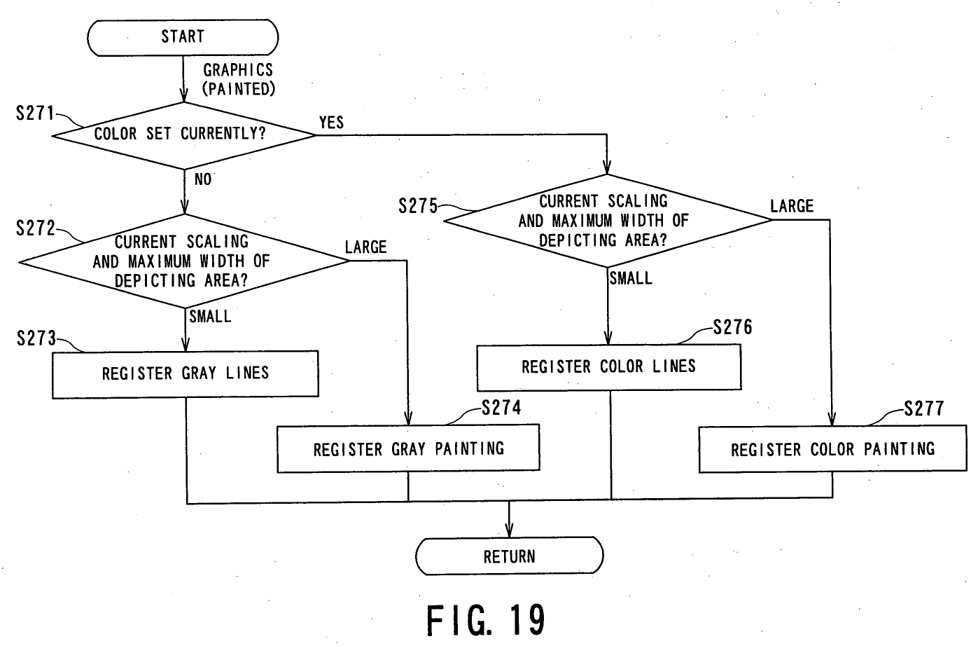

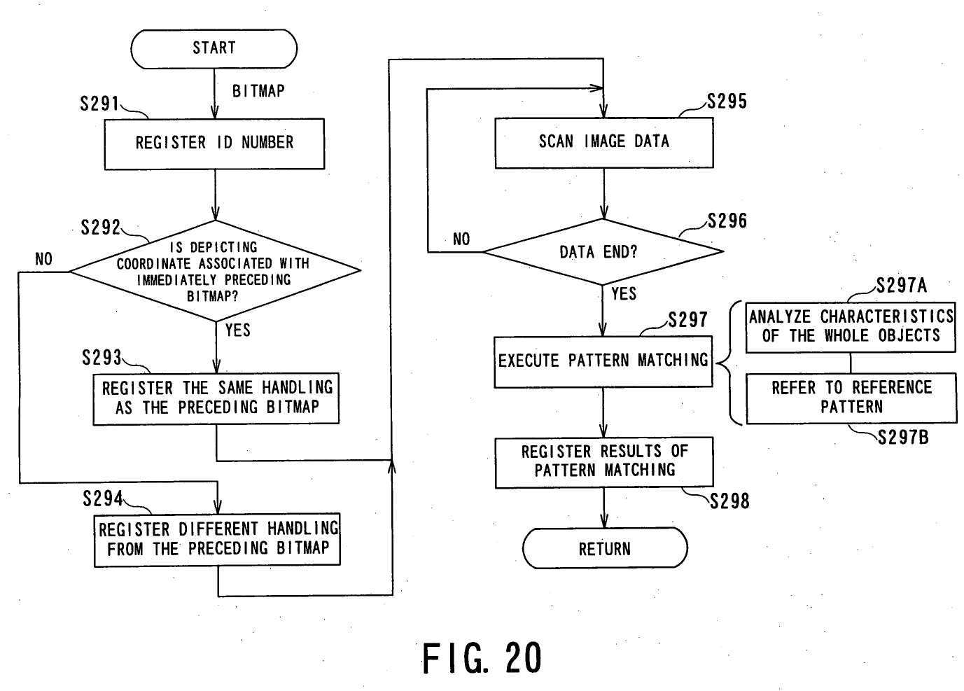

As described above, in the course of performing language analysis of the print data written in PDL, the RIP 18 determines per pixel the type of an object being depicted by the print data, based on the currently set condition of the individual commands and the combination of depicting commands. Examples of this determination are illustrated in the flow diagrams (see FIGS. 16 to 20) described later. The results of the determination are illustrated in FIGS. 3 and 4.

FIG. 3 illustrates a data in a bitmap style in which the determination/classification results are brought into correspondence with the print data pixels at a ratio of 1:1.

In each of the pixels in FIG. 3, a tag value managed by the tag information management table shown in FIG. 4 is recorded. For a certain pixel at a base in the print data, a tag value 00h is allocated, for a gray character (capital), a tag value 01h is allocated, for a color character (capital), a tag value 02h is allocated, for a gray character (small), a tag value 03h is allocated, and for a color character (small), a tag value 04h is allocated, for example, not only being classified into types but also being finely classified into attributes (large size, small size, color, necessity of painting, and the like) belonging to low order.

The tag information management table not only has a function of simply allocating tag values, but also has regions divided depending on the respective types of objects. In particular, the tag information management table is divided into a static allocation region into which text and graphics are mainly classified, and a dynamic allocation region into which bitmap is mainly classified. As to the text and the graphics, results of determination/classification are obtained at the time of the language analysis, and thus tag values can soon be statically allocated.

As to the bitmap data, however, no determination can be made until the entire internal data of the bitmap data object is scanned. Accordingly, in case of bitmap data, an identification number is allocated, and the identification number (e.g. “Image No. 1”) is temporarily registered in the region for management. Thus, in the dynamic allocation region, identification numbers are registered as many as the number of objects consisting of bitmap data. As will be described hereinbelow, when the entire internal data of objects consisting of bitmap data are scanned and the types and attributes are determined, the results of the determinations on the bitmap data objects are brought into correspondence with the temporarily registered identification numbers. Thus, the determination results on the entire objects of bitmap data can be ultimately obtained.

A method for making determinations on an object consisting of bitmap data is now described.

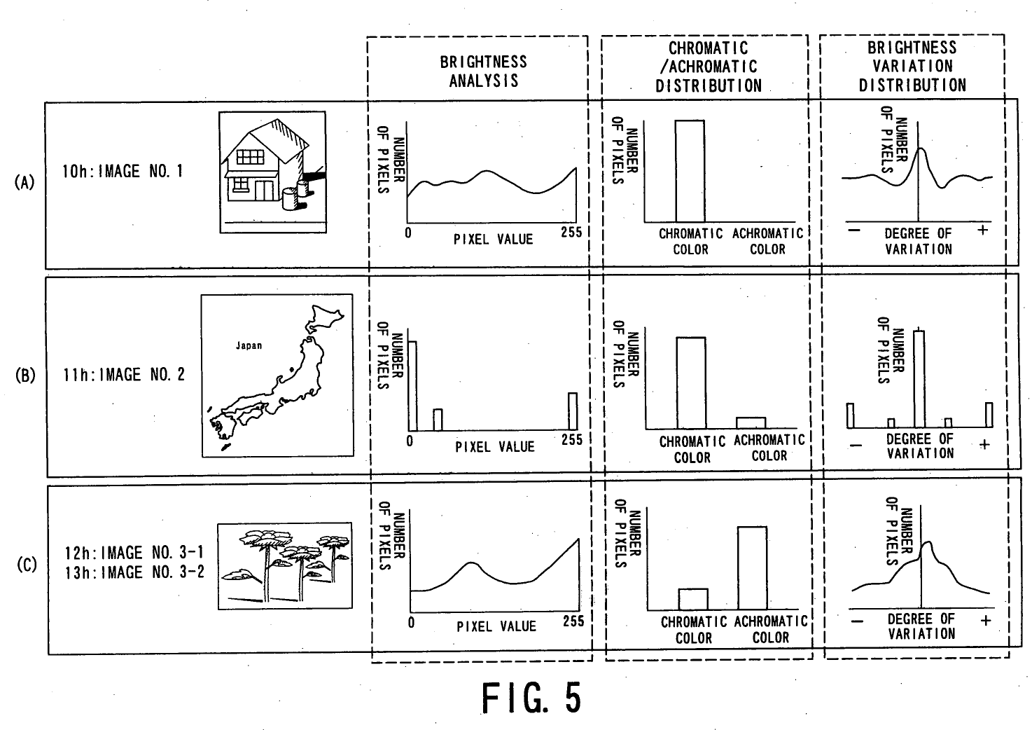

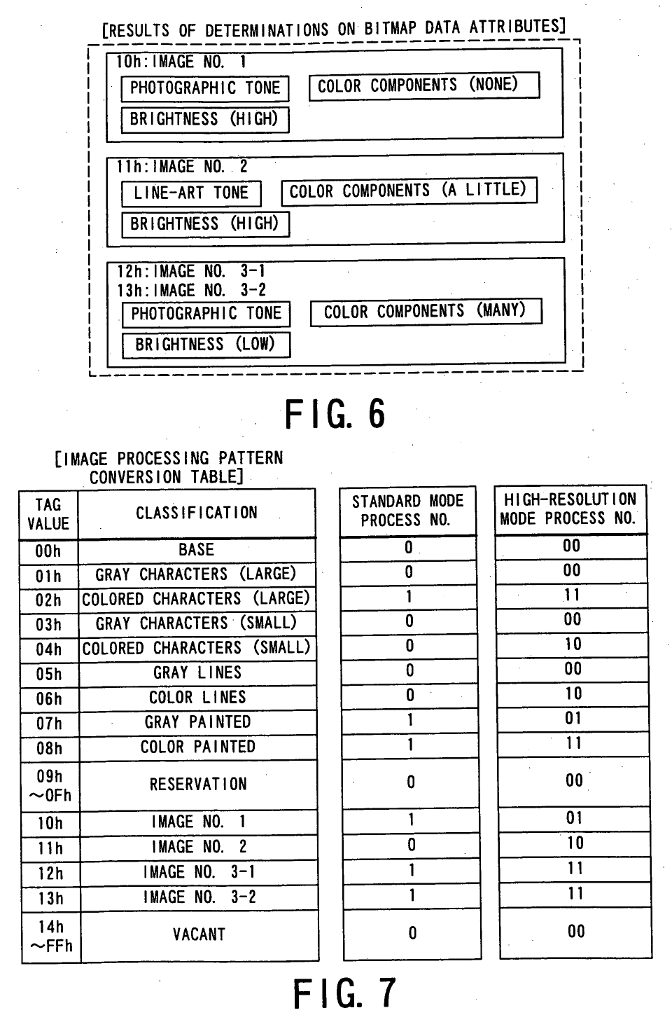

(A), (B) and (C) of FIG. 5 show the results of counting which is associated with the distributions of the brightness (i.e, signal intensity) of pixels consisting the bitmap data objects, the variation in the brightness of adjacent pixels, and the achromatic/chromatic colors. These distribution patterns are matched with the patterns defined in advance, by which the results of classification as shown in FIG. 6 can be obtained for every object. Particularly, as to the attributes, determinations are made in detail depending on the combinations, such as a combination of photographic-tone/line-art-tone, a combination of color component (none)/color component (a little)/color component (many), and a combination of brightness (high)/brightness (low), as shown.

It should be appreciated that this tag information management table is maintained by page unit and that it is a table temporarily used in producing an image processing pattern data.

[Production of Image Processing Pattern Data]

An image processing data is produced using the data per page, showing the results of determinations on the types/attributes of depicted objects that have been obtained by the RIP 18 as shown in FIG. 3, and using a table of image processing pattern conversion shown in FIG. 7. As described above, a standard mode or a high-resolution mode is provided for an image processing data. An image processing data for the standard mode adapts a binary (meaning Process Nos. 0 and 1) data per pixel (see FIG. 8A). In other words, two types of parameter groups are prepared, each consisting of a plurality image processing parameters. An image processing data for the high-resolution mode, on the other hand, adapts a quaternary (meaning Process Nos. 00, 01, 10 and 11) data per pixel (see FIG. 8B). In other words, four types of parameter groups are prepared, each consisting of a plurality image processing parameters.

The way of using the image processing pattern conversion table shown in FIG. 7 is as follows. For example, in case the standard mode is specified, when a data indicating a determination result for a certain pixel, i.e. a tag value, is 02h that equals to a classification “color character (large)”, the data is converted to standard mode Process No. 1, and when a tag value is 04h that equals to a classification “color character (small)”, the data is converted to standard mode Process No. 0. In case the high-resolution mode is specified, when a data indicating a determination result for a certain pixel, i.e. a tag value, is 02h that equals to a classification “color character (large)”, the data is converted to high-resolution mode Process No. 11, and when a tag value is 04h that equals to a classification “color character (small)”, the data is converted to high-resolution mode Process No. 10. In this way, a processing number, i.e. a parameter group is determined for every pixel for the individual standard mode or high-resolution mode depending on the difference in “the type and its subclass attributes of an object”.

FIGS. 8A and 8B show image processing pattern tables sorting out the image processing patterns for the respective modes. FIG. 8A is an image processing pattern table for the standard mode, which defines binary numbers, i.e. the two types of image processing Pattern Nos. 1 and 0. Each of the patterns defines the degrees of half-toning, gamma correction, spatial filtering, color conversion and inking that serve as image processing parameters. The image processing Pattern No. 0 that is one of the binary numbers, adapts a processing pattern which is: half-toning=standard, gamma correction=high, spatial filtering=sharp (intense), color conversion=standard, and inking=slightly excessive. On the other hand, the image processing Pattern No. 1 that is the other of the binary numbers, adapts a processing pattern which is: half-toning=smooth, gamma correction=standard, spatial filtering=standard, color conversion=by gradation, and inking=standard.

FIG. 8B is an image processing pattern table for the high-resolution mode and defines quaternary numbers, i.e. four types of image processing pattern Nos. 00, 01, 10 and 11. The image processing Pattern No. 00 that is one of the quaternary numbers, adapts a processing pattern which is: half-toning=standard, gamma correction=high, spatial filtering=sharp (intense), color conversion=standard, and inking=slightly excessive. The second image processing Pattern No. 01 adapts a processing pattern which is: half-toning=smooth, gamma correction=standard, spatial filtering=standard, color conversion=gradation, and inking=standard. The third image processing Pattern No. 10 adapts a processing pattern which is: half-toning=fine, gamma correction=high, spatial filtering=sharp (intense), color conversion=clear, and inking=slightly excessive. The fourth image processing Pattern No. 11 adapts a processing pattern which is: half-toning=smooth, gamma correction=standard, spatial filtering=sharp (weak), color conversion=by gradation, and inking=slightly less.

In the image processing pattern conversion table shown in FIG. 7, the static allocation region is defined in advance, but the dynamic allocation region cannot be dealt with in the same way. Therefore, the dynamic allocation region is determined based on the data of FIG. 6 showing the results of determination on a bitmap data object, and the preset determination/classification conversion table of FIG. 9 for bitmap.

In the bitmap determination/classification conversion table, classification items are indicated, as shown, which are: color components (none/a little/many), line-art-tone/photographic-tone, and brightness (bright/dark). The table also indicates, as to the individual standard and high-resolution modes, the optimum image processing pattern numbers for the respective attributes which are determined by the combination of the classification items. Thus, by applying each of the three items in the determination results shown in FIG. 6 to the conversion table of FIG. 9, the optimum image processing pattern number for each of the modes is uniquely determined. In this way, the image processing pattern conversion table of FIG. 7 is completed. The groups of the image processing parameters for the respective image processing pattern numbers are as shown in FIGS. 8A and 8B.

Thus, the results of the determinations on the types (attributes) of an object per pixel as shown in FIG. 3 can be converted to image processing pattern numbers with reference to the image processing pattern conversion table shown in FIG. 7, to thereby obtain a data, i.e. an image processing pattern data, in which the pattern numbers are mapped per pixel. FIG. 10 shows an image processing pattern data in the standard mode, corresponding to FIG. 3, and FIG. 11 shows an image processing pattern data in the high-resolution mode, corresponding to FIG. 3.

[Processing of an Image (Bitmap Data) Divided into a Plurality of Blocks]

If an object is formed of bitmap data and the amount of the data is large, the computer 1, a client, may not be capable of processing the bitmap data (image) at a time, and may transmit the data by dividing into a plurality of blocks. Thus, when groups of bitmap data are consecutively transmitted, it is important to determine whether or not the groups of data stem from a single image or they are plurality of separate images.

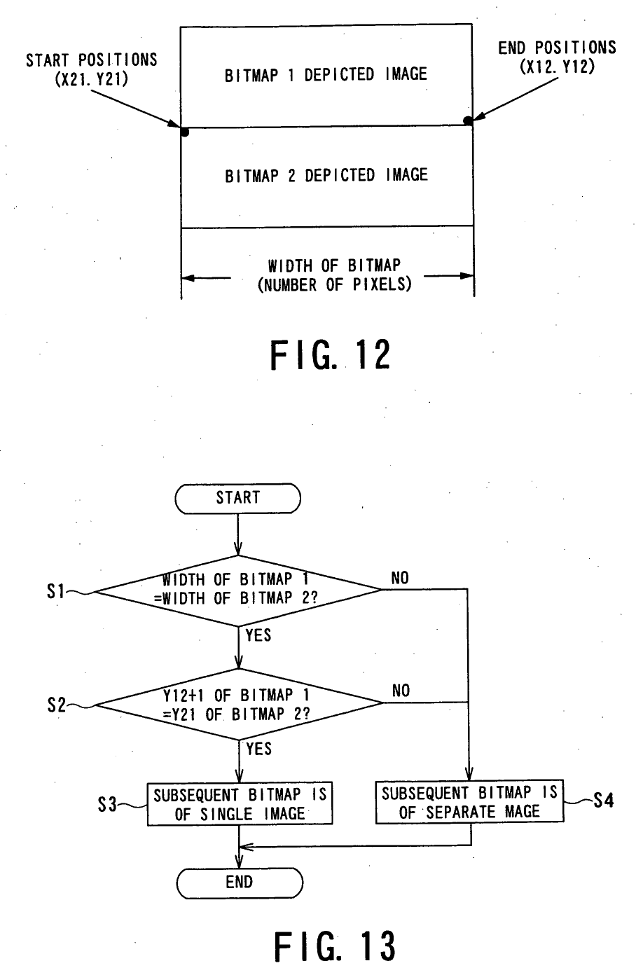

As shown by a frame format in FIG. 12, in order to make the determination, focus is put on end positions (S12, Y12) of an image resulting from a bitmap data group “1”, firstly depicted in a memory, and start positions (X21, Y21) of an image resulting from a bitmap data group “2” subsequently depicted in the memory. Specifically, using the algorithm shown in FIG. 13, determination is made (step S1) as to whether or not the width of the bitmap data group “1” equals to the width of the bitmap data group “2”. If the determination is YES, another determination is made (step S2) as to whether or not the end position Y12+1 equals to the start position Y21. When the determination at step S2 results in YES, the two groups “1” and “2” of bitmap data can be recognized (step S3) as stemming from a single image. Contrarily, when a NO determination is made at step S1 or S2, the two groups “1” and “2” of the bitmap data can be recognized (step S4) as stemming from separate two images.

In the processes described above, when the subsequently transmitted bitmap data is determined as stemming from a single image, determination/classification of the attributes of the object can be omitted to reduce so much the operation load.

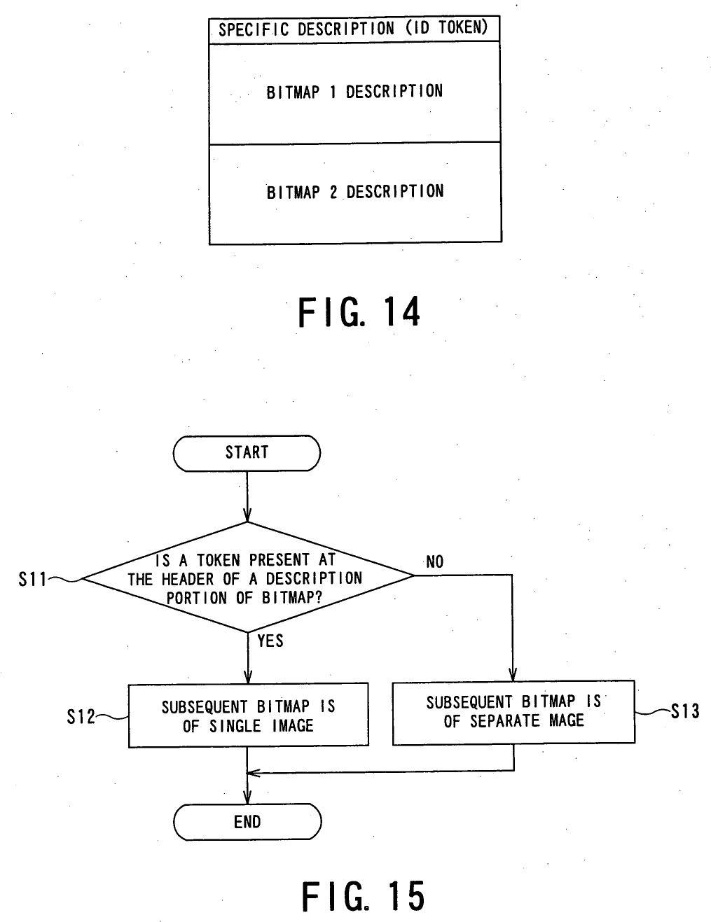

It should be appreciated that the scheme of determinations described above is not limited to the one shown in FIGS. 12 and 13. For example, as shown in FIGS. 14 and 15, determinations based on a PDL may be possible. As shown in FIG. 14, various settings are required for the bitmap data group “1” firstly depicted in the memory. Therefore, in many cases a specific command group (e.g., an identification token) may be described. Because the bitmap data group “2” subsequently depicted in the memory is the same as the first bitmap data group “1”, such a description of the command group may be omitted. This omission may be utilized for enabling determinations. Specifically, as in the algorithm shown in FIG. 15, the header in a description portion of a bitmap data group depicted in a memory is determined (step S11) as to the presence of the specific command group. When the determination is YES, the subsequent bitmap group may be recognized (step S12) as a data stemming from a single image, and when the determination is NO, the subsequent bitmap data group may be recognized (step S13) as a data stemming from a separate image.

The determinations on whether or not an image has been divided from a single image may be performed combining both of the processes of FIGS. 13 and 15 as described above, whereby precision of determinations may be enhanced.

[Description on the Entire Processes]

A course of printing performed by the MFP device 3 is entirely described below with reference to FIGS. 16 to 22, which includes the processes constituting the features of the present invention described hereto.

The series of processes shown in FIG. 16 are executed by the RIP 18 which is under the control of the CPU 20 in the MFP device 3. Thus, the RIP 18 reads (step S20) information specifying an image processing mode. This is a piece of mode specifying information that the CPU 20 has received from a user. Then, upon receipt of a command from the CPU 20 to transmit print data, the RIP 18 reads (step S21), in response, the print data produced by the computer 1. The print data is described in PDL as described above.

The RIP 18 then determines (step S22) whether or not the PDL command for the type of the print data that has been read is a text-depicting command. If YES, because the depicted object is text, determination processes for the attributes are executed (step S23) as a sub-routine as will be described later.

Contrarily, when the determination is NO, the RIP 18 determines (step S24) whether or not the PDL command for the type is a graphics-depicted (line art) command. If YES, because the depicted object is graphics (line art), determination processes for the attributes are executed (step S25) as a sub-routine as will be described later.

If the above determination is still NO, the RIP 18 further determines (step S26) whether or not the PDL command for the type is a graphics-depicted (painted) command. If YES, because the depicted object is graphics (painted), determination processes for the attributes are executed (step S27) as a sub-routine as will be described later.

If the determination at step S28 is NO, the RIP 18 further determines (step S28) whether or not the PDL command for the type is a bitmap-depicting command. If the determination results in YES, a determination is made as to the identicalness of the bitmap data, and pattern mapping of the bitmap data is carried out (step S29) as will be described later.

If the determination at step S29 is NO, it is determined whether or not the command for the type is scaling. If the determination results in YES, the scaling condition is maintained (steps S30 and S31).

Further, if the determination at step S30 is NO, the RIP 18 determines whether or not the command for the type is color setting. If the determination results in YES, the color condition is maintained (steps S32 and S33).

If the determination at step S32 is NO, the RIP 18 determines whether or not the command for the type is control of a depicting position. If the determination results in YES, the depicting position condition is maintained (steps S34 and S35).

If the determination at step S34 is still NO, other commands are executed (step S36). The “other commands” include commands associated with paper size, paper feeding, paper ejection, resetting, page ejection, and the like.

Then, the RIP 18 makes a determination on page end, and if the determination results in YES, control is transferred to preprocessing. If the determination is NO, control returns to step S21 to repeat (step S37) the processes of the steps described above.

As described above, the RIP 18 then prepares (step S38) an image processing pattern data depending on the results of the determinations on the type and attributes of a depicted object, and depending on the specified mode (standard mode or high-resolution mode). Further, the RIP 18 carries out a depicting process of the print data for every page to compact the data, and thereafter stores (steps S39 and S40) the data in the auxiliary memory 17 that serves as a memory. Thereafter, the RIP 18 determines whether or not job has ended, and if not yet ended, control is returned to step S21. If the job is detected as having ended, control is brought to an end (step S41).

(Processes for Determining Attributes of an Object)

The sub-routines are described hereunder which are executed at steps S23, S25, S27 and S29 described above.

<Text>

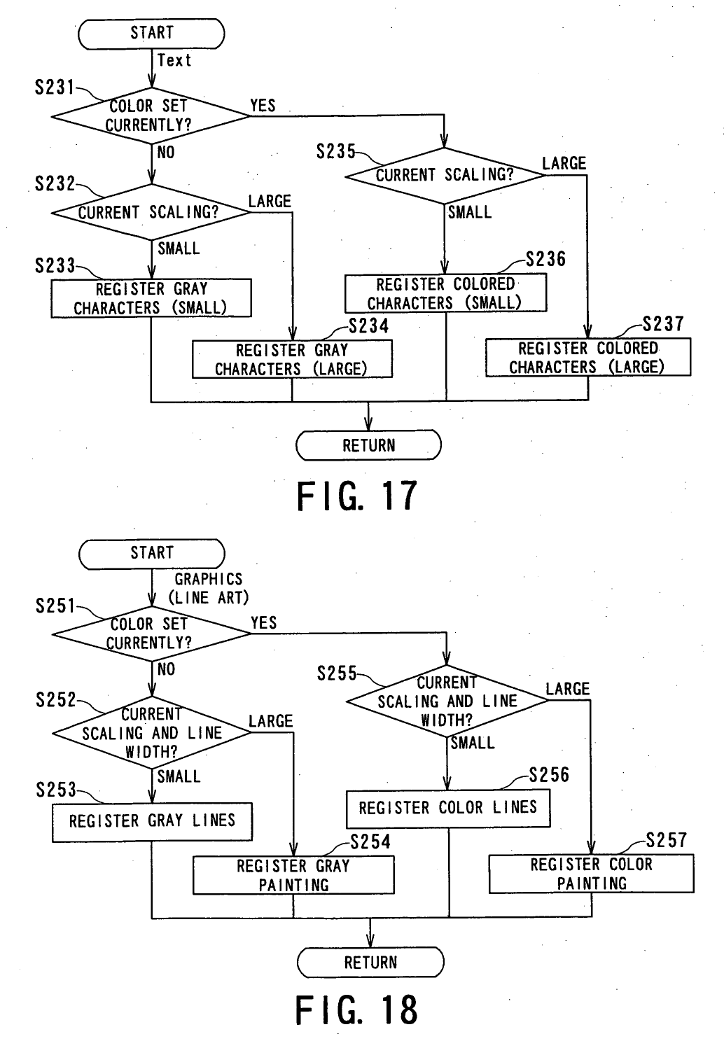

The sub-routine of FIG. 17 shows a series of processes at step S23, in case the type of an object is text, for determining attributes of the object other than the type. If no color is set currently, and scaling is specified as “small” currently (“NO” at step S231, and “small” at step S232), the RIP 18 recognizes an attribute of the text data as gray characters (small) and registers (step S233) the results of the recognition and an image processing pattern corresponding to the specified mode for image processing. If no color is set currently, and scaling is “large” (“NO” at step S231, and “large” at step S232), the RIP 18 recognizes an attribute of the text data as gray characters (large) and registers (step S234) the results of the recognition and an image processing pattern corresponding to the specified mode for image processing.

On the other hand, if color is set currently, and scaling is specified as “small” currently (“YES” at step S231, “small” at step S235), the RIP 18 recognizes an attribute of the text data as colored characters (small) and registers (step S236) the results of the recognition and an image processing pattern corresponding to the specified mode for image processing. Further, if a color is set currently, and scaling is “large” (“YES” at step S231, and “large” at step S235), the RIP 18 recognizes an attribute of the text data as colored characters (large) and registers (step S237) the results of the recognition and an image processing pattern corresponding to the specified mode for image processing.

Thus, the color setting command and the scaling command in the PDL commands may be combined to determine the text data as to fine attributes, i.e. gray or colored, or small characters or large characters, by which image processing patterns can be set.

<Graphics (Line Art)>

The sub-routine of FIG. 18 shows a series of processes at step S25, in case the type of an object is graphics (line art), for determining attributes of the object other than the type. If no color is set currently, and scaling and line width are specified as being “small” currently (“NO” at step S251, and “small” at step S252), the RIP 18 recognizes an attribute of the graphics data as being gray lines, and registers (step S253) the results of the recognition and an image processing pattern corresponding to the specified mode for image processing. Further, if no color is set, and scaling and line width are specified as being “large” (“NO” at step S251, and “large” at step S252), the RIP 18 recognizes an attribute of the graphics data as being painted, and registers (step S254) the results of the recognition and an image processing pattern corresponding to the specified mode for image processing.

On the other hand, if color is set currently, and scaling and line width are specified as being “small” currently (“YES” at step S251, and “small” at step S255), the RIP 18 recognizes an attribute of the graphics data as being colored lines, and registers (step S256) the results of the recognition and an image processing pattern corresponding to the specified mode for image processing. Further, if color is set, and scaling and line width are specified as being “large” (“YES” at step S251, and “large” at step S255), the RIP 18 recognizes an attribute of the graphics data as being painted, and registers (step S257) the results of the recognition and an image processing pattern corresponding to the specified mode for image processing.

Thus, the color setting command and the scaling/line width command in the PDL commands may combined to determine the graphics (line art) data as to more fine attributes, i.e. gray or colored, or line art or painted, by which appropriate image processing patterns can be set.

<Graphics (Filling)>

The sub-routine of FIG. 18 shows a series of processes at step S27, in case the type of an object is graphics (painted), for determining attributes of the object other than the type. If no color is set currently, and scaling and maximum width of a depicting area are specified as being “small” currently (“NO” at step S271, and “small” at step S272), the RIP 18 recognizes an attribute of the graphics data as being gray, and registers (step S273) the results of the recognition and an image processing pattern corresponding to the specified mode for image processing. Further, if no color is set, and scaling and maximum width of a depicting area are specified as being “large” (“NO” at step S271, and “large” at step S272), the RIP 18 recognizes an attribute of the graphics data as being gray, and registers (step S274) the results of the recognition and an image processing pattern corresponding to the specified mode for image processing.

On the other hand, if color is set currently, and scaling and maximum width of a depicting area are specified as being “small” currently (“YES” at step S271, and “small” at step S275), the RIP 18 recognizes an attribute of the graphics data as being colored lines, and registers (step S276) the results of the recognition and an image processing pattern corresponding to the specified mode for image processing. Further, if color is set, and scaling and maximum width of a depicting area are specified as being “large” (“YES” at step S271, and “large” at step S275), the RIP 18 recognizes an attribute of the graphics data as being color painted, and registers (step S277) the results of the recognition and an image processing pattern corresponding to the specified mode for image processing.

Thus, the color setting command and the command for scaling/maximum width of a depicting area in the PDL commands may be combined to determine the graphics (painted) data as to more fine attributes, i.e. gray or colored, or painted or not painted, by which image processing patterns appropriate for the results can be set.

<Bitmap>

The sub-routine of FIG. 18 shows a series of processes at step S29, in case the type of an object is bitmap, for determining attributes of the object other than the type. As mentioned above, in case of a bitmap data, the RIP 18 registers an identification number (e.g. Image Nos. 1, 2, 3-1 or 3-2) in the tag management table shown in FIG. 4, and allocates (step S291) the identification number to the bitmap data for every pixel. Thus, as shown in FIG. 3, temporary results of determinations are obtained on the attributes of the bitmap data.

Then, the RIP 18 determines (step S292) whether or not the currently read bitmap data group is associated with the previous one (whether or not the current group has been divided from a single image), based on the processes similar to the ones shown in FIGS. 12 and 13, or FIGS. 14 and 15 described above. If the determination is YES, i.e. if a determination is made as being associated, an instruction is given (step S293) so that the current bitmap is handled in the same manner as the previous one. If the determination is NO, i.e. if a determination is made as not being associated, an instruction is given (step S294) so that the current bitmap is handled separate from the previous one. The instruction herein means the processing of.

After that, the RIP 18 scans (steps S295 and S296) the currently read print data in its entirety to perform pattern matching (step S297). In the pattern matching, the entire area of the bitmap data is analyzed (step S295A) as to the attributes relating to brightness and chroma. The results of the analysis are then compared (step S295B) with a reference pattern which has been set and maintained in advance. Thus, determination results can be obtained as shown in FIG. 6.

Then, the RIP 18 allocates (step S298) an image processing pattern for every pixel, referring to the bitmap data determination/classification conversion table shown in FIG. 9 and according to a specified mode for image processing.

The completion of the determinations on the attributes of bitmap data can replenish the process numbers for the individual modes, i.e. parameter groups as image processing patterns, on the part of bitmap in the image processing pattern conversion table shown in FIG. 7. Thus, an ultimate image processing pattern conversion table is completed.

As a result, in the preprocessing executed at step S38 in FIG. 16, an image processing pattern can be allocated to every pixel for each of the modes by bringing the results of determination exemplified in FIG. 3 into correspondence with the image processing pattern conversion table exemplified in FIG. 7. Accordingly, the image processing pattern data in the standard mode as illustrated in FIG. 10, or the image processing pattern data in the high-resolution mode as illustrated in FIG. 11, can be obtained.

(Printing Processes)

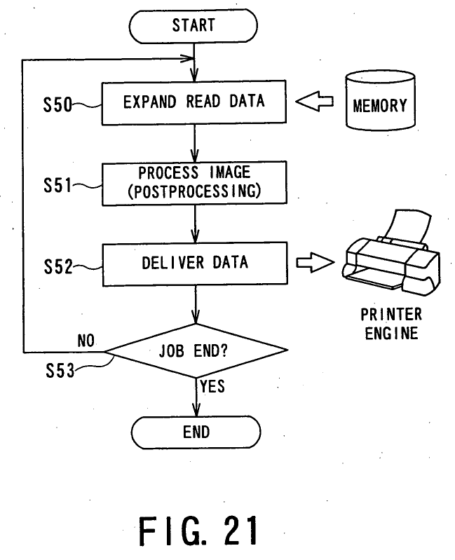

In response to a printing command from the CPU 20, the postprocessor 19 reads the print image data that has been subjected to preprocessing, depicting and compaction, from the auxiliary memory 17 to expand the data (FIG. 21, step S50).

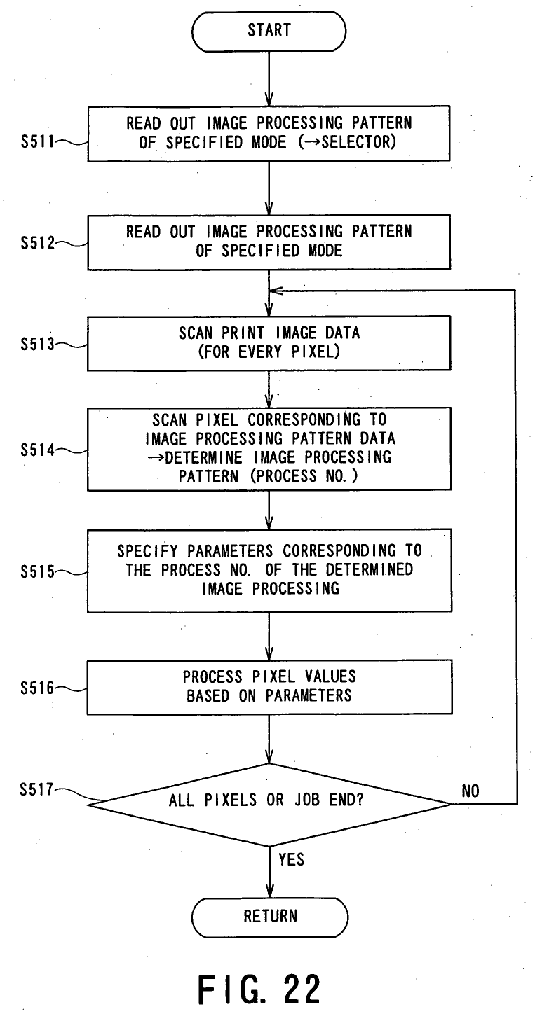

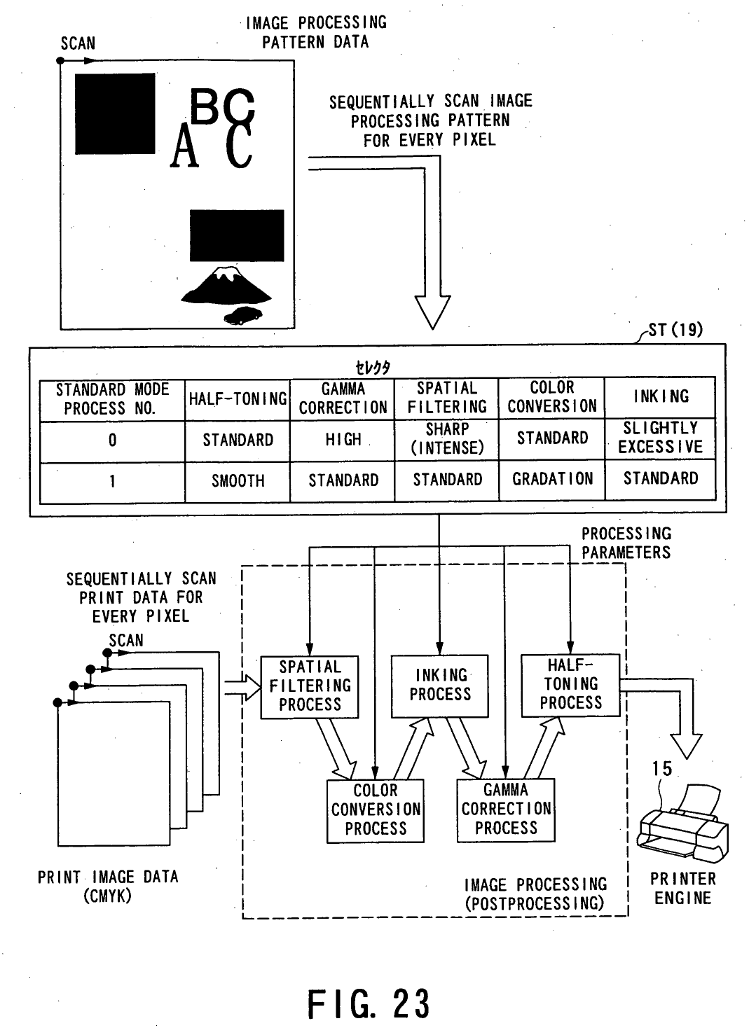

The postprocessor 19 then executes (step S51), as postprocessing, image processing for every pixel of the expanded color print image data (CMYK) based on the various image processing parameters that belong to the image processing pattern of a specified mode. The sub-routine for this process is shown in FIG. 22, and its process flow is shown in FIG. 23.

As shown in FIG. 22, the postprocessor 19 reads out an image processing pattern corresponding to a specified image processing mode, i.e. the standard mode or the high-resolution mode, for storage (step S511) in a selector ST (see FIG. 23) of the processor 19. The selector ST in FIG. 23 shows an example in which an image processing pattern of the standard mode, consisting of two processing numbers (0 or 1), i.e. two parameter groups, has been called up.

The postprocessor 19 then reads out (step S512) in the temporary memory region of the processor the image processing pattern data for a print data corresponding to the specified image processing mode.

Subsequently, the postprocessor 19 scans the pixel in the first address of the already read out color print image data (CMYK) to read out the pixel value. Likewise, the corresponding pixel in the image processing pattern data is scanned to determine (steps S513 and S514) a process number (i.e. process No. 0 or 1) of the image processing pattern. Thus, the plurality of parameters (half-toning, gamma correction, spatial filtering, color conversion and inking) that belong to the parameter group of the determined process number are specified, and values of the parameters are determined (step S516).

As shown in FIG. 23, the postprocessor 19 thereafter executes (step S516), for the pixel value of the scanned pixel, a spatial filtering process (sharp contents or standard contents), color a conversion process (standard color gradation or enhanced gradation), an inking process (slightly excessive or standard amount of black toner), a gamma correction process (high correction or standard correction for enhancing brightness), and half-toning process (standard or smooth) in an appropriate order.

The postprocessor 19 then repeats execution (step S517) of the processes at steps S513 to S517 for the pixel of the next address in the print image data. These processes are continually executed until all the pixels are finished or until the termination of job.

As described above, after all the pixels of print image data are processed using image processing patterns of specified parameter groups, the data is printed by the printer 15.

In this way, according to the MFP device 3 as an image producing apparatus of the present embodiment, three depicted objects, i.e. text, graphics and bitmap data, are finely determined as to not only their types but also their attributes other than the types, and the results of the determinations are mapped on the image processing patterns prepared in advance. Accordingly, because an optimum image processing pattern, i.e. an optimum parameter group, for every pixel can be selected, image data before printing can be processed using image processing parameters of considerably finer details than in a conventional device.

Consequently, image processing can be performed after being considered, for example, as to its character size, whether or not the characters are colored, and whether the graphics is of fine lines or painted (of gray color or color painted). As a result, as to small characters or fine lines, sharpness in the details may be enhanced even if they are of finer detailed halftone. Contrarily, as to large characters or painted portions, a coarse half-toning process is provided. Thus, mechanical influences, such as jittering, may be considerably avoided to thereby inhibit occurrences of uneven density.

When an object consists of a bitmap data, image processing may be performed, not being caught up in merely the type of the object. Particularly, in case of bitmap data, the emphasis may be on gradation, as in the case of photographic data (natural image), or sometimes, the bitmap data may rather be classified into text or graphics data, as in the case of CAD data based on characters or lines, or scanned data based on written documents, which may allow gradation to be at a standard level. In addition, in case of bitmap data in which a map is depicted by fine lines (in gray) with colored characters therein, coloring processes of such data may allow the gray line portions to be typically printed with black which is a mixture of not only a black toner but also colored toners. Therefore, if misregistration is caused, color shift may also be caused, resulting in bad printing. Moreover, in case of bitmap data in which extremely pale gray or pale color portions, such as thin pencil lines, are present, priority is placed on color processing and thus density of the pale gray portions may not be sufficiently ensured.

The embodiment according to the present invention may take measures for such problems involved in a bitmap data by providing image processing not sticking to the type as bitmap. Specifically, by determining fine attributes of bitmap data, consideration is extended to such degrees as whether or not gradation should be enhanced, whether or not density correction of gray should be enhanced, or whether or not color processing should be suppressed.

Thus, according to the present embodiment, qualities of a printed image may be improved to a great extent.

Such finely determined information is not retained as it is, but is retained as image processing pattern data that has been mapped to an image processing pattern. Accordingly, the structure of the selector ST used for the postprocessor 19 may simplified, and thus the capacity of data that has to be temporarily stored for printing, can be reduced.

As can be seen from the above description, the RIP 18 of the present embodiment is adapted to perform preprocessing, depicting and data compaction, in addition to the analysis of the PDL commands, which has been the primary processing of conventional RIPs. However, a preprocessor, a depicting device and a data compressor may be separately provided, and these units may be entrusted with their processes. Alternatively, a preprocessor alone may be provided separate from the RIP, and may allow the preprocessor to carry out preprocessing, depicting and data compaction. Additionally, data expansion and preprocessing may be included in the processes of the RIP. Alternatively, one or more processors may be provided in addition to the conventional RIP to appropriately allocate preprocessing, depicting, data compaction, data expansion, and postprocessing to the processors.

The present embodiment has been described for a case where functions for implementing the invention are internally recorded in an apparatus in advance. However, apparatuses are not limited to this, but the similar functions may be downloaded from a network, or the similar functions may be stored in a recording medium for installation to an apparatus. Such a recording medium may be of any form, such as a CD-ROM, if only it can store programs and the apparatus can read data therefrom. Alternatively, such functions that are obtained by installation or downloading may be of the types which can be realized in harmony with an OS (operating system) in an apparatus.

It should be appreciated that the present invention is not limited to the embodiment and its modifications described above, but may be implemented by a skilled artisan in various forms in combination with conventional art, without departing from the spirit of the present invention as described in the scope of the claims.

What is claimed is:

1. An image producing apparatus which produces images by performing printing of print data comprising:
an object determining device for determining the type of an object depicted by said print data upon analysis of the commands described in said print data, and determining attributes other than said object type as determined;
a pattern setting device for setting an image processing pattern consisting of a group of one or more image processing parameters depending on the determination on the type of said object and the results of the determinations on the attributes other than the type of said object, made by said object determining device; and
a print data processor for providing said print data with image processing based on the image processing parameters determined by said image processing pattern which has been set by said pattern setting device.

2. The image producing apparatus as defined in claim 1, wherein said image processing pattern consists of a plurality of image processing patterns, and at least some of said one or more image processing parameters of each of the plurality of image processing patterns have different parameter values between image processing patterns depending on the difference in the type and the attributes of said object.

3. The image producing apparatus as defined in claim 2, wherein
the parameter values of each of said plurality of image processing patterns are stored in switchable and readable tables;
said pattern setting device comprises pattern data preparing means which switches and reads out the image processing pattern in said tables, for every pixel of said print data, depending on the results of the determinations on the type and the attributes of said object, and maps an image processing pattern data, for every pixel, indicating said image processing pattern as read out to prepare the pattern data; and
said data processor is configured so that said print date may be provided with image processing for every pixel on the basis of said image processing parameters determined by the image processing pattern which is indicated by the image processing data prepared by said pattern data preparing means.

4. The image producing apparatus as defined in claim 3, wherein
said print data is described in a page description language (PDL); and
said object determining device, said pattern setting device and said print data processor are configured to operate for every page of said print data.

5. The image producing apparatus as defined in claim 1, wherein
the attributes of said object whose type has been determined include at least one of size, color and depicting position of said object.

6. The image producing apparatus as defined in claim 1, wherein
said image processing parameters include half-toning, gamma correction, spatial filtering, color conversion and inking of said object.

7. The image producing apparatus as defined in claim 1, wherein
said print data is described in a page description language (PDL);
said object determining device comprises type determining means for determining the type of said object by determining whether said object consists of text data, line-art graphics data, painted graphics data, or bitmap data, and attribute determining means for determining attributes of said object other than the type depending on the determination made by said type determining means as to whether said object consists of said text data, said line-art graphics data, said painted graphics data, or said bitmap data.

8. The image producing apparatus as defined in claim 7, wherein
said type determining means comprises bitmap type determining means for determining whether or not the type of said object is of bitmap data;
said attribute determining means comprises bitmap attribute determining means for determining attributes other than the type of said object, when said object has been determined as consisting of bitmap data by said bitmap type determining means; and
said pattern setting device comprises bitmap pattern setting means for setting said image processing pattern in said bitmap data.

9. The image producing apparatus as defined in claim 8, wherein
said bitmap attribute determining means is means for analyzing the attributes associated with the pixel values of the entire bitmap data forming said object; and
said bitmap pattern setting means comprises means for temporarily managing a depicting region of said bitmap data with management information, means for determining said image processing pattern depending on said analyzed attributes of said bitmap data, and means for setting said image processing pattern on said object from said bitmap data by associating said management information with said determined image processing pattern.

10. The image producing apparatus as defined in claim 8, wherein
said pattern setting device comprises division determining means for determining whether or not said bitmap data is in a divided state in which said bitmap data is divided into a plurality of data groups, when said object has been determined by said bitmap type determining means as being a type consisting of bitmap data, and instructing means for instructing application of a single image processing pattern to said plurality of data groups, when the state has been determined as being divided by said division determining means.

11. The image producing apparatus as defined in claim 10, wherein
said division determining means is configured to determine said divided state with respect to two bitmap data based on the presence of a specific command described at the header of a description portion in each of a first bitmap data and a subsequent bitmap data.

12. The image producing apparatus as defined in claim 10, wherein
said division determining means is configured to determine said divided state with respect to two bitmap data based on the positional relation between depicting end positions of a first bitmap data and depicting start positions of a subsequent bitmap data, and on an identicalness relation in the width between both of the bitmap data.

13. The image producing apparatus as defined in claim 10, wherein
said division determining means is configured to execute an AND operation for a first determination on said divided state with respect to two bitmap data based on the presence of a specific command described at the header of a description portion in each of a first bitmap data and a subsequent bitmap data, and for a second determination on said divided state based on the positional relation between the depicting end positions of a first bitmap data and the depicting start positions of a subsequent bitmap data, and on an identicalness relation in the width between both of the bitmap data.

14. The image producing apparatus as defined in claim 1, comprising a printer for performing printing of said print data processed by said print data processor.

15. The image producing apparatus as defined in claim 1, wherein said print data is a data for printing which has been produced by a printer driver installed in a computer.

16. A method for producing images by performing printing of print data comprising:
determining the type of an object depicted by said print data upon analysis of the commands described in said print data, and determining attributes other than the type of said object as determined;
setting an image processing pattern consisting of a group of one or more image processing parameters depending on the determination on the type of the object and the results of the determinations on the attributes; and
providing said print data with image processing based on said image processing parameters determined by said set image processing pattern.

17. The method for producing images as defined in claim 16, wherein
said image processing pattern consists of a plurality of image processing patterns, and at least some of said one or more image processing parameters of each of the plurality of image processing patterns have different parameter values between image processing patterns depending on the difference in the type and the attributes of said object.

18. A program readably recorded in a memory and is executable by a computer, wherein, by executing the program, the computer is functioned as:
object determining means for determining the type of an object depicted by said print data upon analysis of the commands described in said print data, and determining attributes other than the type of said object as determined;
pattern setting means for setting an image processing pattern consisting of a group of one or more image processing parameters depending on the determination on the type of said object and the results of the determinations on the attributes made by said object determining means; and
print data processing means for providing said print data with image processing based on said image processing parameters determined by said image processing pattern which has been set by said pattern setting means.
